(19) United States
(12) Patent Application Publication
(10) Pub. No.: US 2024/0399404 A1
(43) Pub. Date: Dec. 5, 2024

(54) PAINTING WORK MANAGEMENT DEVICE, PAINTING WORK MANAGEMENT PROGRAM, AND RAILWAY VEHICLE PAINTED USING PAINTING WORK MANAGEMENT DEVICE

(71) Applicant: Hitachi, Ltd., Tokyo (JP)

(72) Inventors: Shuichi BABA, Tokyo (JP); Nobuhito KATSUMURA, Tokyo (JP); Osamu UHARA, Tokyo (JP)

(21) Appl. No.: 18/619,451

(22) Filed: Mar. 28, 2024

(30) Foreign Application Priority Data
May 29, 2023 (JP) 2023-087713

(51) Int. Cl. B05B 12/12; G06T 7/00; G06T 7/70

(52) U.S. Cl. CPC B05B 12/124; G06T 7/0004; G06T 7/70; G06T 2207/30156

(57) ABSTRACT

A painting work management device measures a position and a posture of a painting gun with respect to a surface to be painted, and calculates a formed film thickness distribution. The painting work management unit detects 3D data of the object to be painted, a distance of the painting gun with respect to the surface to be painted, an inclination angle and a moving speed of the painting gun, and accurately calculates the film thickness distribution formed on the surface to be painted based on a model formula representing a film thickness distribution pattern according to a shape of the surface to be painted in the 3D shape data of the object to be painted. When motion of the painting gun by the worker is abnormal, and when the film thickness distribution is insufficient or excessive, support is provided to prompt the worker to perform appropriate work.

### CROSS-REFERENCE TO RELATED APPLICATION

The present application claims priority from Japanese application JP2023-087713, filed on May 29, 2023, the content of which is hereby incorporated by reference into this application.

### BACKGROUND OF THE INVENTION

### Field of the Invention

The present invention relates to a painting work management device and a painting work management program, and realizes a painting work management device that enables a worker to form an appropriate paint film thickness when manually painting an object to be painted, such as a railway vehicle.

### Description of the Related Art

Many structures such as buildings are painted for the purpose of adding design, protection, etc. Furthermore, in moving bodies such as railway vehicles and automobiles, it is necessary to make a surface of a paint film smooth in order to provide an aesthetic appearance and reduce aerodynamic drag. The paint film may have a single layer. However, in many cases, the paint film may have a plurality of layers to ensure a characteristic in which the surface of the paint film is made smooth. For example, when a paint film is formed on a metal surface, the paint film is formed according to a procedure of applying anti-rust primer after roughening the metal surface by blasting etc./drying, applying putty to ensure smoothness by covering irregularities on the metal surface/drying/polishing, surfacer application to cover minute irregularities on a putty surface/drying/polishing, applying an intermediate coat/drying/polishing, top coat application to give a top surface a design effect/drying/polishing.

Painting is generally performed manually by workers or by using automatic machines such as robots. When a worker performs painting, the worker uses a spray, a brush, a roller, etc. However, it is difficult to quantitatively detect a paint film thickness during painting in real time or immediately after painting, and detection of a paint film thickness strongly depends on the skill level of the worker. For this reason, painting quality varies depending on the skill level of the worker, and it takes time to train skilled workers.

Meanwhile, when a robot is used, equipment investment is expensive, and when paint containing an organic solvent is used, it is necessary to have an explosion-proof specification, which further increases the equipment investment amount. In addition, a large space is required to install the robot, and when an object to be painted is heated, it is necessary to evacuate the robot or move object to be painted to perform heating, so that easily introducing the robot is difficult.

In robot painting, there is a method of acquiring a paint film thickness distribution through simulation. For example, JP 2006-122830 A discloses a “paint film thickness simulation method” as simulation technology. According to the simulation method disclosed in JP 2006-122830 A, a film thickness distribution value at a painting gun position is acquired based on a reference pattern, and film thickness distribution values are integrated to acquire a film thickness distribution value for an object to be painted. Furthermore, J P 2010-274185 A discloses a “paint film thickness prediction method” as simulation technology. According to the simulation method of JP 2010-274185 A, a predicted paint film thickness is output to an output region of a spatial mesh set based on a three-dimensional (3D) shape of a surface to be painted from a model indicating fluid behavior of a conveying fluid and paint particles, and actual measured values of a particle state and a fluid state in an input region of the spatial mesh.

### SUMMARY OF THE INVENTION

In general, in either case where painting is performed manually by a worker or by using a robot, it is necessary to pay attention to a paint film thickness. When a painted film is thinner than a predetermined thickness (predetermined film thickness), defects may occur, such as protection provided by painting being weakened or a desired aesthetic appearance not being achieved. When the film is thicker than the predetermined film thickness, a defect such as swelling or cracking may occur due to a solvent remaining in the paint film and evaporating, or an aesthetic appearance may be degraded due to unevenness, etc. as a result of a combination thereof. In addition, using a large amount of paint leads to an increase in costs. To prevent these problems, it is important to ensure an appropriate film thickness over the entire surface to be painted of the object to be painted.

The simulation method illustrated in JP 2006-122830 A is a calculation method for obtaining a paint film thickness value based on a predetermined painting condition. In practice, due to an influence of changes in a position or an inclination of a paint spot within a surface to be painted resulting from a curve surface or an irregularity shape of the surface to be painted in addition to deviation of a movement path of a painting machine from a prerequisite painting condition or deviation from a predetermined position of an object to be painted, there is a possibility that a large discrepancy may occur in a position or angle condition between the painting machine and the painting spot within the surface to be painted, and errors in a paint film thickness calculation value may increase. As a method to deal with this, there is a method of measuring an exact position or shape of the surface to be painted three-dimensionally in advance, or measuring a distance and angle of a painting gun with respect to the object to be painted in real time during painting. However, the former requires an increase in man-hours, and thus is difficult to implement operationally. Further, the latter is technically difficult to implement since a state of the painted surface immediately after painting (paint before drying and curing) is unstable.

An object of the invention to solve the above problem is to provide a painting work management device and a painting work management program allowing a worker to form an appropriate paint film thickness by visualizing the paint film thickness in consideration of deviation from a movement path of a painting machine or a predetermined position of an object to be painted and an influence of a curved surface or an irregularity shape of a surface to be painted when manually painting the object to be painted by the worker.

Another object of the invention to solve the above problem is to provide a railway vehicle on which paint having an appropriate film thickness is formed using the painting work management device.

An example of a “painting work management device” of the invention for solving the above-mentioned problem is a painting work management device configured to manage painting work for performing painting by spraying paint to an object to be painted using a painting gun, and includes a measurement unit configured to measure a position and a posture of the painting gun with respect to a surface to be painted of the object to be painted, and a painting work management unit configured to calculate a film thickness distribution formed on the surface to be painted of the object to be painted by spraying the paint. The painting work management unit is configured to hold shape data of the object to be painted, specify a distance of the painting gun with respect to a surface to be painted of the shape data of the object to be painted, an inclination angle of the painting gun with respect to the surface to be painted of the shape data of the object to be painted, and a moving speed of the painting gun, and calculate a film thickness distribution formed on the surface to be painted of the object to be painted based on information related to the distance, the inclination angle, and the moving speed of the painting gun and information of a model formula representing a film thickness distribution pattern corresponding to the shape data of the object to be painted.

In addition, an example of a “painting work management method” of the invention is a painting work management method of managing painting work for performing painting by spraying paint to an object to be painted using a painting gun, and includes steps of measuring, by a measurement unit, a position and a posture of the painting gun with respect to a surface to be painted of shape data of the object to be painted, specifying, by a painting work management unit, a distance, an inclination angle, and a moving speed of the painting gun with respect to the surface to be painted from the position and the posture of the painting gun, and calculating by the painting work management unit, a film thickness distribution formed on the surface to be painted of the object to be painted based on information related to the distance, the inclination angle, and the moving speed and information of a model formula representing a film thickness distribution pattern corresponding to a shape of the surface to be painted in the shape data of the object to be painted. Furthermore, a computer program is provided to cause a computer to execute these steps.

According to the invention, it is possible to provide a painting work management device and a painting work management program capable of supporting a worker in forming an appropriate paint film thickness during working by visualizing the paint film thickness in consideration of deviation from a movement path of a painting machine or a predetermined position of an object to be painted and an influence of a curved surface or an irregularity shape of a surface to be painted when manually painting the object to be painted, and a railway vehicle painted using the painting work management device. In addition, since a region where paint is insufficient on a surface to be painted of an object to be painted is specified and displayed during working, a worker can easily perform additional painting, and it is possible to suppress variation in painting quality depending on the skill level of the worker and to provide a high-quality object to be painted.

Problems, configurations, and effects other than those described above will be made clear by the following description of the embodiments.

### BRIEF DESCRIPTION OF THE DRAWINGS

FIG. 1 is a diagram illustrating a relationship between a painting machine and an object to be painted during painting work according to an embodiment of the invention;

FIG. 2 is a block diagram illustrating a configuration of a painting work management device 10 according to an embodiment of the invention;

FIG. 3 is a block diagram illustrating a detailed configuration of a painting work management unit 130 of FIG. 2;

FIG. 4 is a diagram for describing coordinate data of an object to be painted when a position of the object to be painted is specified using a marker 30;

FIG. 5 is a flowchart illustrating a procedure for positioning shape data of an object to be painted to a position of the object to be painted in a measurement coordinate system of a measurement unit;

FIG. 6A is an explanatory diagram illustrating an inclination angle (horizontal angle) of a painting gun 100 with respect to a surface to be painted 22;

FIG. 6B is an explanatory diagram illustrating an inclination angle (vertical angle) of the painting gun 100 with respect to the surface to be painted 22;

FIG. 6C is an explanatory diagram illustrating occasional 3D position coordinates of the painting gun tip 105 and coordinates of the surface to be painted in a direction of each painting gun tip direction vector;

FIG. 7 is an explanatory diagram illustrating types of painting patterns;

FIG. 8 is an explanatory diagram illustrating a trajectory of the painting gun tip 105;

FIG. 9A is an explanatory diagram illustrating a tendency of a paint film thickness pattern due to a difference between the painting gun 100 and the surface to be painted 22;

FIG. 9B is an explanatory diagram illustrating a tendency of a paint film thickness pattern due to a difference in painting gun moving speed;

FIG. 9C is an explanatory diagram illustrating a tendency of a paint film thickness pattern due to a difference between the painting gun 100 and a vertical inclination of the surface to be painted 22;

FIG. 10A is an explanatory diagram illustrating a tendency of a paint film thickness pattern when the surface to be painted 22 is a flat surface;

FIG. 10B is an explanatory diagram illustrating a tendency of a paint film thickness pattern when the surface to be painted 22 is a curved surface;

FIG. 11A is an explanatory diagram illustrating a paint film thickness distribution in a pattern width direction in a painting pattern;

FIG. 11B is an explanatory diagram illustrating a geometric relationship between a painting gun tip and the surface to be painted when the surface to be painted 22 has a curved shape within a pattern width region and the painting gun is tilted in a vertical direction;

FIG. 12 is a diagram illustrating a painting condition management table 160 according to a paint/painting gun condition;

FIG. 13 is a diagram illustrating a display example of a film thickness distribution image;

FIG. 14 is a flowchart illustrating a flow of painting work according to an embodiment of the invention; and

FIG. 15 is a flowchart illustrating a detailed procedure of S113 of FIG. 14.

### DETAILED DESCRIPTION OF THE PREFERRED EMBODIMENTS

Embodiments of the invention will be described below with reference to the drawings. However, the invention should not be construed as being limited to contents described in the embodiments illustrated below. Those skilled in the art will easily understand that a specific configuration can be changed without departing from the spirit or gist of the invention. Note that, in each figure for describing the embodiments, the same components are given the same names and symbols as much as possible, and repeated descriptions thereof will be omitted.

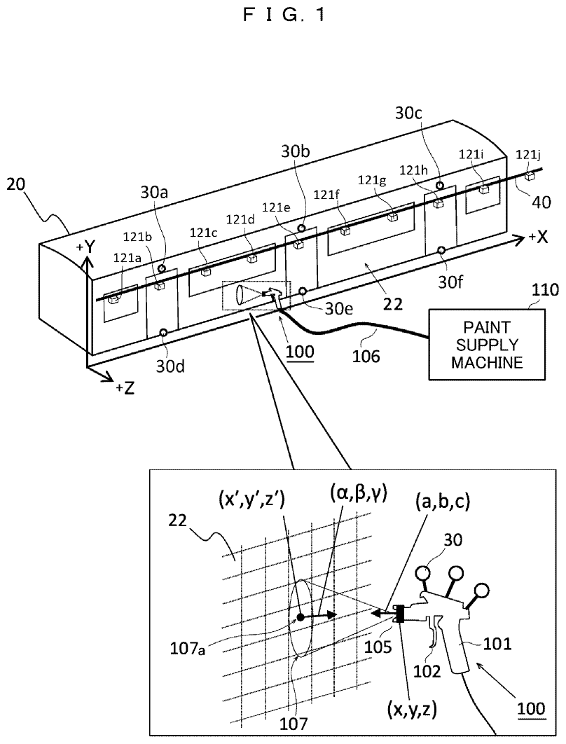

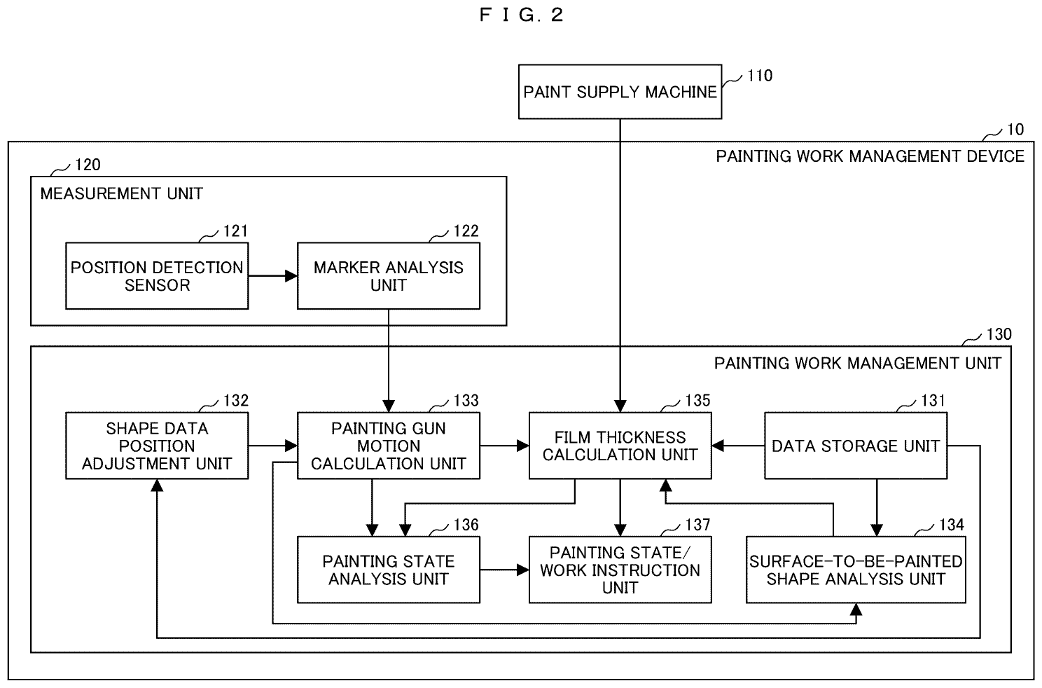

A manual painting method using a painting work management device according to an embodiment of the invention will be described using an example in which an object to be painted is a railway vehicle 20. FIG. 1 is a diagram illustrating a relationship between a painting gun 100 and an object to be painted during painting work. As painting equipment for painting the railway vehicle 20, a painting machine having a painting gun 100, a paint supply machine 110, and a hose 106 are used. The paint supply machine 110 sucks up liquid paint stored in a paint tank (not illustrated) using a pump and supplies the liquid paint to the painting gun 100 via the hose 106. In addition, high-pressure air is also supplied to the painting gun 100 by a compressor (not illustrated). Here, the amount of paint supplied from the paint supply machine 110 to the painting gun 100, the amount of paint sprayed from the painting gun 100, a spray direction, etc. are managed by a painting work management device 10, which will be described later with reference to FIG. 2.

The railway vehicle 20 illustrated in FIG. 1 is one car of a subway train or a train operated as a plurality of cars, and an example of FIG. 1 illustrates a state when a worker paints a left-side surface of the car using the painting gun 100 (However, the worker is not illustrated). A well-known pneumatic-type painting gun that has been widely used in the past can be used as the painting gun 100, and the painting gun 100 is configured so that motion of the painting gun 100 (an inclination angle with respect to a painted surface and a moving speed of the painting gun) and a relative position with respect to a surface to be painted can be specified. Here, a plurality of markers 30 is attached to the painting gun 100, and a tip 105 of the painting gun 100 relative to each of the markers 30 is detected. A plurality of cameras 121a to 121j is arranged around the railway vehicle 20 to detect a position of the painting gun 100.

Three markers 30a to 30c are provided on an upper side of the left-side surface of the railway vehicle 20, and three markers 30e to 30f are provided on a lower side of the left-side surface. Even though the example of FIG. 1 illustrates an example in which three markers 30 are provided on the painting gun 100, the number of markers 30 provided is arbitrary as long as the number is three or more. Each of the markers 30 serves as an index for accurately detecting a position of the painting gun 100, and mainly measures three of a distance of the object to be painted 20 of the painting gun 100 with respect to the surface to be painted 22, an inclination angle of the painting gun 100 with respect to a surface of the object to be painted 20 (the surface to be painted 22), and a moving speed of the painting gun 100. As the marker 30, for example, it is possible to use a visually identifiable sticker mark, an optically emissive device, or an optically reflective member.

The cameras 121a to 121j are a plurality of optical input devices fixed to a mounting frame 40 along the surface to be painted 22 (the left-side surface in the example of FIG. 1) of the railway vehicle 20, which captures a moving image and transmits a digital image in real time to the painting work management device 10 (described later in FIG. 2). In FIG. 1, a horizontal mounting frame 40 extending in an X-direction is provided. However, the frame 40 may be provided not only in one stage but also in a plurality of stages in a vertical direction to further increase the number of cameras. Positions are set so that a distance between the cameras 121a to 121j and the surface to be painted 22 is greater than a distance between the painting gun tip 105 and the surface to be painted 22 during painting work, and it is preferable to set a positional relationship such that both the painting pattern 107 and the painting gun tip 105 during work can be photographed by the cameras 121a to 121j.

The painting gun 100 is an air spray-type painting gun that sprays supplied paint using air to perform painting, atomizes paint by spraying pressurized air (high-pressure air) supplied from the compressor, etc. (not illustrated) through the hose 106 to paint supplied from the paint supply machine 110 to the painting gun 100, and sprays a mist of paint onto the surface to be painted 22 to perform painting. As illustrated in an enlarged view on a lower side of FIG. 1, the painting gun 100 has a handle portion 101 held by the worker, and a trigger lever 102. To realize the painting work management device 10 (described later in FIG. 2) according to this embodiment, the painting gun 100 can include a sensor for optically identifying the marker 30 and a 3-axis sensor (not illustrated) that detects a direction in which the tip 105 of the painting gun 100 is directed among 3-axis directions of X, Y, and Z-directions. Furthermore, motion of the painting gun 100 may be detected by configuring the painting gun 100 as in the past and analyzing a plurality of images acquired by the cameras 121a to 121j. Here, a +Z-direction indicates a direction away from the surface to be painted 22 in horizontal and vertical directions.

In this embodiment, the painting work management device 10, which will be described later in FIG. 2, calculates 3D position coordinates (x, y, z) of the painting gun tip 105, a tip direction vector (a, b, c) indicating a direction of the painting gun 100, and a normal vector (α, β, γ) at intersection coordinates (x′, y′, z′) of the surface to be painted 22 in a direction of the painting gun tip direction vector (a, b, c) (hereinafter, painting center position coordinates). Using these coordinate information and vector information, a state of motion of the painting gun 100 can be detected in detail.

A painting pattern 107 formed in each time unit is, for example, elliptical. When a painting worker paints a side surface of the railway vehicle 20, the painting worker performs painting by separating the painting gun 100 from a painting center 107a of the surface to be painted (the surface of the railway vehicle 20) by several hundred mm and moving the painting gun 100 in the vertical direction (+Y-direction of FIG. 1) while reciprocating the painting gun 100 in the horizontal direction (+X-direction of FIG. 1). By this operation of the painting gun 100, painting is performed in a certain range in the horizontal direction (a range of a width of several hundred mm from an upper part to a lower part of the car), and when this is finished, the worker moves in a longitudinal direction of the car (X direction of FIG. 1) and paints the entire side surface of the car while repeating a similar painting gun operation. Note that the painting type is not limited to the air spray type, and it is possible to adopt any form of air gun, airless gun, electrostatic gun, etc.

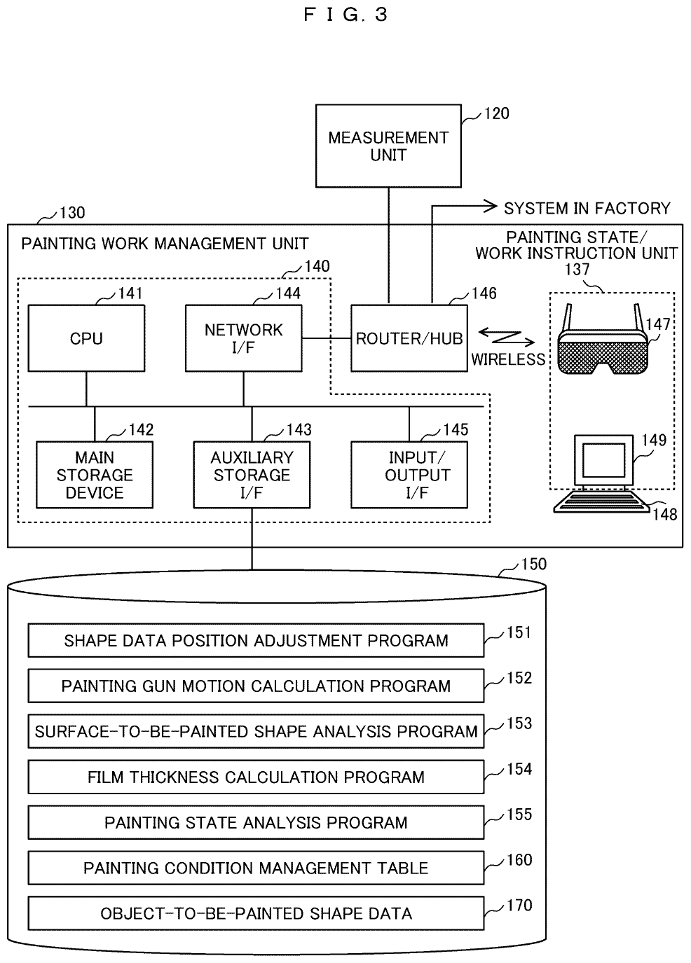

FIG. 2 is a block diagram illustrating a configuration of the painting work management device 10 according to an embodiment of the invention. The painting work management device 10 includes a measurement unit 120 and a painting work management unit 130. A hardware/software configuration of the painting work management unit 130 can be realized by, for example, a general information processing device such as a PC (Personal Computer) 140, which will be described later with reference to FIG. 3. The measurement unit 120 measures motion of the painting gun 100 during painting and a position relative to the surface to be painted 22. The painting work management unit 130 analyzes a measurement result by the measurement unit 120, calculates and analyzes a film thickness distribution formed on the surface to be painted 22 from an analysis result, and issues an instruction to the worker based on the analysis result.

The measurement unit 120 is installed in a space where painting work is performed (hereinafter referred to as a painting work space), and includes a plurality of position detection sensors 121 (cameras 121a to 121j illustrated in FIG. 1) and a marker analysis unit 122. Each of the position detection sensors 121 is an optical sensor including a known camera means such as a CCD or a CMOS. As another configuration, light (visible light or infrared light) may be emitted from the position detection sensors 121 and the position detection sensors 121 may detect light reflected by the markers 30, or the markers 30 themselves may be used as light emitting bodies and light directly emitted by the markers 30 may be detected by the position detection sensors 121. Optical signals detected by two or more of the plurality of position detection sensors 121a to 121j are analyzed by the marker analysis unit 122 to calculate the painting gun tip direction vector (a, b, c), the intersection coordinates (x′, y′, z′) of the surface to be painted 22, etc.

The painting work management unit 130 includes a data storage unit 131 that imports, from the outside, and holds shape data of the object to be painted 20, a shape data position adjustment unit 132 that positions the shape data of the object to be painted with a position of the object to be painted in the measurement coordinate system of the measurement unit, a painting gun motion calculation unit 133 that calculates motion of the painting gun 100 with respect to the surface to be painted of the shape data of the object to be painted, a surface-to-be-painted shape analysis unit 134 that analyzes a shape of the surface to be painted from shape data information of the object to be painted, a film thickness calculation unit 135 that calculates a film thickness distribution formed on the surface to be painted from an analysis result of the surface-to-be-painted shape analysis unit 134 and an analysis result of painting gun motion, a painting state analysis unit 136 that determines instruction content given to the worker based on a calculation result of the film thickness calculation unit 135, and a painting state/work instruction unit 137 that displays instruction content given to the worker and a film thickness distribution based on the film thickness calculation unit 135 and the painting state analysis unit 136. The data imported and held by the data storage unit 131 includes a painting condition management table and information on a model formula that three-dimensionally represents a painted surface of the object to be painted.

Each of the units 131 to 137 in the painting work management unit 130 can be realized by software using a computer program for a processor such as a PC to execute functions of the respective units. However, as long as the functions illustrated in FIG. 2 can be executed, a system in which a computer program is executed externally using a cloud system, etc. may be used.

FIG. 3 is a block diagram illustrating a detailed configuration of the painting work management unit 130 of FIG. 2. In the painting work management unit 130, the respective functions are realized by a CPU (Central Processing Unit) 141 of a personal computer (PC) 140 executing a plurality of computer programs (151 to 155). The PC 140 includes a primary main storage device 142 such as a semiconductor memory, an auxiliary storage interface (hereinafter interface is referred to as “I/F”) 143 allowing data to be input and output to and from an auxiliary storage device 150 via a data bus, a network I/F 144, and an input/output I/F 145 for visually displaying information to the worker, a supervisor, etc. and receiving an input operation from the worker, the supervisor, etc., which are connected by a data bus. In this embodiment, the CPU 141 is used as an example of the processor. However, any other semiconductor device may be used as long as the semiconductor device is an entity that executes a predetermined process.

The main storage device 142 usually mainly includes a volatile memory such as a RAM, and stores a program executed by the CPU 141, data to be referred to, and data calculated by the CPU. The auxiliary storage I/F 143 is an interface for connecting the auxiliary storage device 150. The auxiliary storage device 150 is a large-capacity secondary storage device, and can be configured using a known nonvolatile storage device, such as an HDD (Hard Disk Drive) or an SSD (Solid State Drive). A plurality of programs is stored in the auxiliary storage device 150, and is read by the main storage device 142 including a RAM, etc. when each program is executed. Note that the auxiliary storage device 150 may be configured to be incorporated in the painting work management unit 130.

A program stored in the auxiliary storage device 150 is a program that realizes a function of each of the units 132 to 136 of FIG. 2, and includes a shape data position adjustment program 151, a painting gun motion calculation program 152, a surface-to-be-painted shape analysis program 153, a film thickness calculation program 154, and a painting state analysis program 155. Further, information necessary for execution of each program is also stored. A painting condition management table 160 and object-to-be-painted shape data 170 are stored here. Work record data and various programs and data (none of which are illustrated) processed by the CPU 141 are further recorded in the auxiliary storage device 150.

The network I/F 144 is an interface for the painting work management device 10 to connect with external equipment via a network, and the PC 140 is connected by wire or wirelessly to various external models, such as the measurement unit 120 illustrated in FIG. 2, a wearable terminal such as an HMD (Head Mounted Display) 147 that displays a film thickness distribution calculation result or an instruction to the worker, and another system in a factory. The worker who performs painting work can visually acquire various information from the painting work management unit 130 by wearing the HMD 147.

The input/output I/F 145 is connected to an input device 148 that inputs data such as a painting condition to the painting work management device, and an output device 149 that outputs output data from the PC 140 of each screen (a painting condition input screen, device operation buttons, a film thickness distribution calculation result display screen, etc.) of control software that controls the painting work management device. The input device 148 can include a known keyboard and mouse, and the output device 149 can include a known monitor. However, for example, the input device 148 and the output device 149 may include a touch panel. Further, the numbers of output devices 149 and HMDs 147 are arbitrary, and the output device 149 and the HMD 147 may be combined into one thereof. Furthermore, as the output device 149, a small matrix display device, such as a touch-type liquid crystal display, may be provided on a top surface of the painting gun 100, or a mobile terminal owned by the worker may be used.

The painting state analysis program 155 calculates a film thickness distribution formed on the painted surface of the object to be painted based on information related to a distance, an inclination angle, and a moving speed of the painting gun 100 and model formula information representing a film thickness distribution pattern according to a shape of the surface to be painted 22 in shape data of the object to be painted (railway vehicle 20), and determines whether or not the film thickness distribution formed on the painted surface is normal. Here, a 3D model based on 3D CAD data included in a design drawing may be used as the shape data of the object to be painted (the railway vehicle 20), and when the 3D model of the railway vehicle 20 is positioned to a position of the railway vehicle 20 in an xyz coordinate system set in the painting space, the shape of the surface to be painted 22 can be detected in detail using the 3D model of the railway vehicle 20 positioned by the CPU 141.

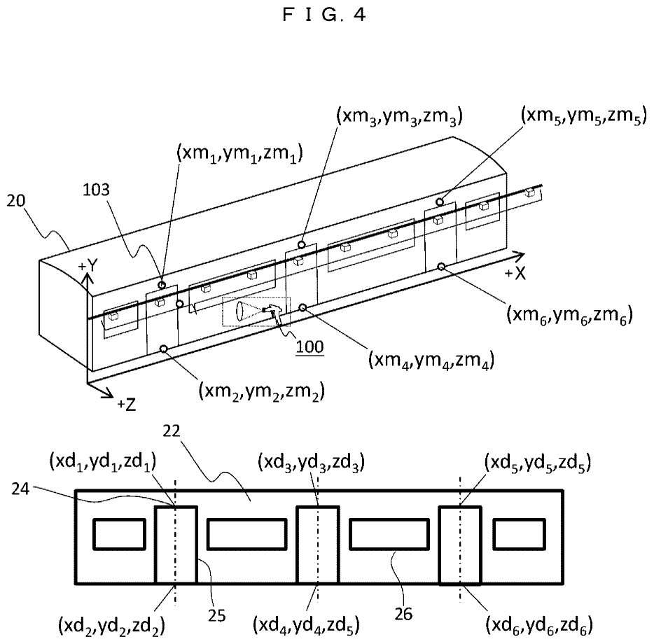

FIG. 4 is a diagram for describing coordinate data of the object to be painted when a position of the object to be painted is specified using the marker 30. The xyz coordinate system (an axis perpendicular to the surface to be painted is set to a z-axis, a horizontal axis on the surface to be painted is set to an x-axis, and a vertical axis on the surface to be painted is set to a y-axis) is set on the surface to be painted 22. As a method of detecting each marker position using each of the position detection sensors 121, light (visible light or infrared light) may be emitted from the position detection sensors to the painting gun 100, and the position detection sensors 121 may detect a plurality of rays of light reflected by retroreflective markers 30a to 30g each reflecting light in an emitting direction, or the markers 30a to 30g themselves may be used as light emitting bodies and light directly emitted by the markers 30a to 30g may be detected using the position detection sensors 121. It is preferable that the markers 30a to 30g are removed before starting painting work, and the portions bonded to the vehicle are preferably made of a sealing material. Respective coordinates of the position detection sensors 121 are obtained in advance by the CPU 141 as 3D position coordinates (xmₖ, ymₖ, zmₖ); (0≤k≤n, n: number of markers) using 3D shape data of the car. By analyzing the optical signal from the markers 30 detected by the plurality of position detection sensors 121 using the marker analysis unit 122 of the measurement unit 120, it is possible to calculate the respective 3D position coordinates (xmₖ, ymₖ, zmₖ); (0≤k≤n, n: number of markers) of a plurality of markers 30 in the measurement coordinate system of the measurement unit 120 based on the triangulation principle commonly used in a motion capture system, etc.

At each feature position of the surface to be painted 22, a reference position is specified as coordinate values (xmₖ, ymₖ, zmₖ), and shape data for the reference position is acquired by the CPU 141. The CPU 141 can precisely identify a range and a shape of the surface to be painted 22 on which painting is performed by considering a position of shape data obtainable from design data of the railway vehicle 20, for example, a door 25 or a window 26, for coordinate values (xdₖ, ydₖ, zdₖ); (0≤k≤n) of a position 24 corresponding to each feature position on the surface to be painted 22.

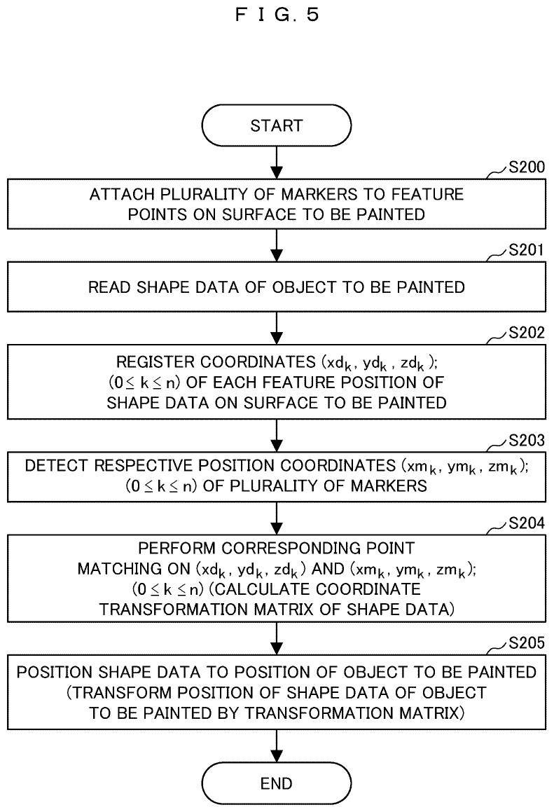

FIG. 5 illustrates a procedure for positioning shape data of the object to be painted to a position of the object to be painted. Before painting, the object to be painted (the surface to be painted 22 of the railway vehicle 20) and the shape data of the object to be painted held by the painting work management device 10 are positioned. First, feature positions on surface to be painted 22 (for example, in the case of the railway vehicle 20, a position where coordinates can be specified, such as a window on the side surface or a center of an entrance/exit opening) are selected, and a plurality of markers 30 is attached to the respective feature points on the surface to be painted (step 200, note that, in the figure, “step” is indicated by the letter “S”). Next, the CPU 141 reads the shape data (3D model data) 157 of the object to be painted 20 from the auxiliary storage device 150 to the main storage device 142 (step 201), and registers coordinate values of each feature position of the shape data on the surface to be painted (step 202).

Next, the CPU 141 detects each position of the markers 30 using the plurality of position detection sensors 121 of the measurement unit 120 installed in the painting work space (step 203). An optical signal detected by any one of the plurality of position detection sensors 121a to 121g is analyzed by the marker analysis unit 122 of the measurement unit 120, so that 3D position coordinates (xmₖ, ymₖ, zmₖ) can be calculated.

Next, the marker analysis unit 122 performs corresponding point matching on the coordinate values (xmₖ, ymₖ, zmₖ) of each feature position on the surface to be painted calculated in step 203 and coordinate values (xdₖ, ydₖ, zdₖ); (0≤k≤n) of the position 24, etc. corresponding to each feature position of the shape data on the surface to be painted 22, and calculates a coordinate transformation matrix of shape data minimizing a difference between coordinate values of each feature position of an actual object to be painted and each coordinate value of shape data corresponding to each feature position (step 204). Besides, the shape data position adjustment unit 132 uses the coordinate transformation matrix calculated in step 204 to position the shape data of the object to be painted to the position of the object to be painted in the measurement coordinate system of the measurement unit 120 (step 205). Through the above processing, since the actual object to be painted 20 can be replaced with the shape data of the object to be painted, it is possible to numerically express the position and shape of the surface to be painted 22 in the measurement coordinate system of measurement unit 120.

During painting by the worker, the plurality of position detection sensors 121 of the measurement unit 120 occasionally detects each marker position at certain short time intervals (Δt) during painting. Furthermore, optical signals detected at certain time intervals (Δt) are analyzed by the marker analysis unit 122 of the measurement unit 120, and the occasional 3D position coordinates (x, y, z) of the painting gun tip 105 in the painting work space and the painting gun tip direction vector (a, b, c) indicating the direction of the painting gun tip 105 are calculated. The painting gun tip direction vector (a, b, c) starts from a position of the painting gun tip 105.

The painting gun motion calculation unit 133 of the painting work management unit 130 calculates a distance of the painting gun tip 105 to the surface to be painted 22: l, an inclination angle of the painting gun tip 105 with respect to the surface to be painted 22 (horizontal angle: ϕ and vertical angle: θ), a moving speed of the painting gun 100: v, levelness of a trajectory of the painting gun 100, and an interval of the trajectory of the painting gun 100 representing a state of the painting gun motion from the 3D position coordinates (x, y, z) of the painting gun tip 105, the tip direction vector (a, b, c), and the normal vector (α, β, γ) at the coordinates (x′, y′, z′) of the surface to be painted in the direction of the painting gun tip direction vector (a, b, c) (hereinafter, painting center position coordinates) calculated by the marker analysis unit 122.

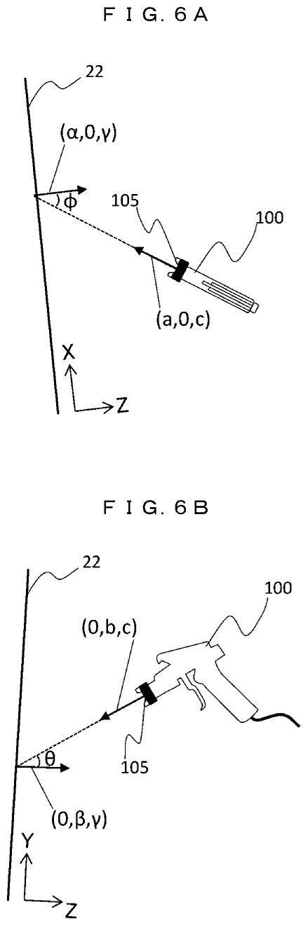

Next, a method of setting the xyz coordinate system on the surface to be painted 22 and calculating the distance of the painting gun tip 105 to the surface to be painted 22: l, the inclination angle of the painting gun tip 105 with respect to the surface to be painted 22 (horizontal angle: ϕ and vertical angle: θ), and the moving speed of the painting gun 100: v will be described with reference to FIGS. 6A, 6B, and 6C.

FIG. 6A illustrates a plan view (xz plane) of the painting gun 100 and the surface to be painted 22 viewed from a y-axis direction in the coordinate system. At this time, an angle of the painting gun tip 105 with respect to a horizontal cross section of the surface to be painted 22 is the horizontal angle ϕ illustrated in the figure. Orthogonal projections of the painting gun tip direction vector (a, b, c) and the normal vector (α, β, γ) on the surface to be painted in the direction of the painting gun tip direction vector to the xz plane are (a, 0, c), and (α, 0, γ), respectively, illustrated in the figure, and the horizontal angle ϕ is expressed by an angle formed by these respective vectors and can be determined using Equation (1).

$$\begin{matrix}[ Equation 1 ] & \\ ϕ = arccos ( \frac{a \cdot α + c \cdot γ}{\sqrt{( {a}^{2} + {c}^{2} ) ( {α}^{2} + {γ}^{2} )}} ) & ( 1 )\end{matrix}$$

FIG. 6B illustrates a plan view (yz plane) of the painting gun and the surface to be painted viewed from an x-axis direction in the coordinate system. At this time, an angle of the painting gun tip 105 with respect to a vertical cross section of the surface to be painted 22 is the vertical angle θ illustrated in the figure. Orthogonal projections of the painting gun tip direction vector (a, b, c) and the normal vector (α, β, γ) on the surface to be painted in the direction of the painting gun tip direction vector to the yz plane are (0, b, c), and (0, β, γ), respectively, illustrated in the figure, and the vertical angle θ is expressed by an angle formed by these respective vectors and can be determined using Equation (2).

$$\begin{matrix}[ Equation 2 ] & \\ θ = arccos ( \frac{b \cdot β + c \cdot γ}{\sqrt{( {b}^{2} + {c}^{2} ) ( {β}^{2} + {γ}^{2} )}} ) & ( 2 )\end{matrix}$$

In addition, FIG. 6C illustrates the occasional 3D position coordinates data string 300 (xₖ, yₖ, zₖ) of the painting gun tip 105 and coordinates (xₖ′, yₖ′, zₖ′) of the surface to be painted in the direction of each painting gun tip direction vector during painting. In this instance, the occasional distance of the painting gun tip 105 with respect to the surface to be painted: l can be obtained from (xₖ, yₖ, zₖ) and (xₖ′, yₖ′, zₖ′) using Equation (3), and the moving speed of the painting gun 100: v can be obtained from the occasional 3D position coordinate data (xₖ, yₖ, zₖ) of the painting gun tip 105, 3D position coordinate data (xₖ₋₁, yₖ₋₁, zₖ₋₁) of the painting gun tip 105 detected at previous timing from (xₖ, yₖ, zₖ), and a detection time interval (Δt) of the painting gun tip position using Equation (4).

$$\begin{matrix}[ Equation 3 ] & \\ l = \sqrt{{( {x}_{k} - {x}_{k}^{′} )}^{2} + {( {y}_{k} - {y}_{k}^{′} )}^{2} + {( {z}_{k} - {z}_{k}^{′} )}^{2}} & ( 3 )\end{matrix}$$

$$\begin{matrix}[ Equation 4 ] & \\ v = \frac{\sqrt{{( {x}_{k} - {x}_{k - 1} )}^{2} + {( {y}_{k} - {y}_{k - 1} )}^{2} + {( {z}_{k} - {z}_{k - 1} )}^{2}}}{Δ t} & ( 4 )\end{matrix}$$

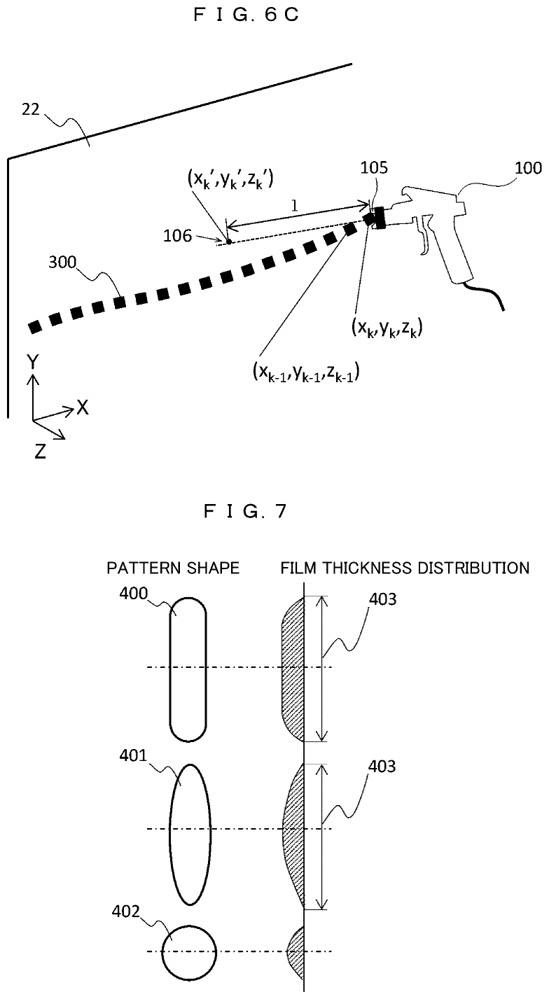

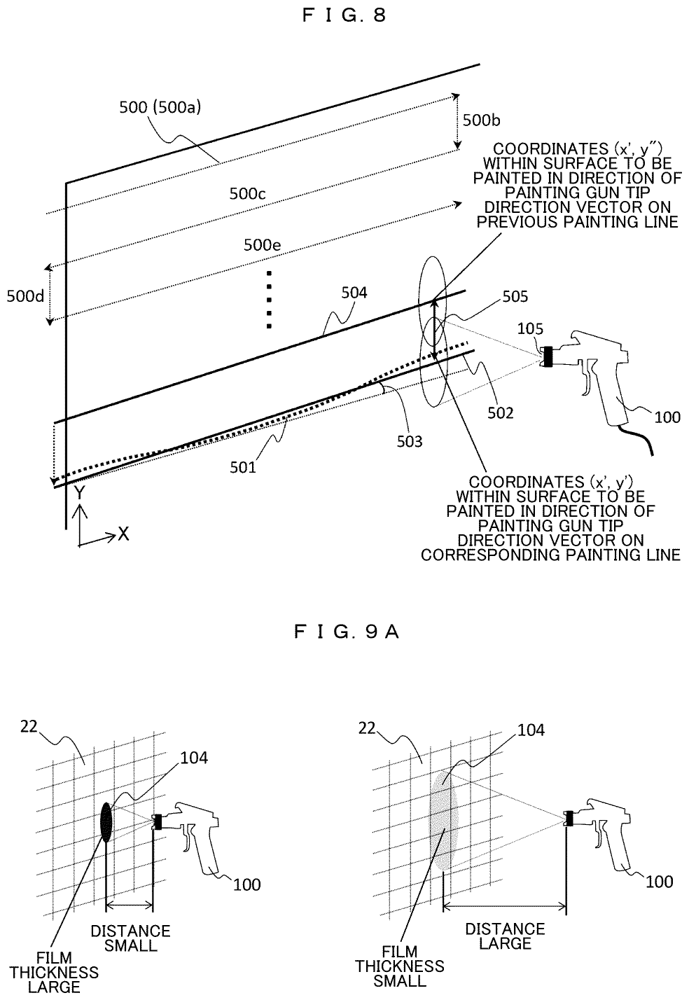

Next, the trajectory (levelness of the trajectory and the interval of the trajectory) of the painting gun 100 will be described using FIGS. 7 and 8.

A shape of a painting pattern illustrated in FIG. 7 changes depending on the settings of the painting gun 100. The painting gun 100 is referred to as a hand spray gun which is widely used, and depending on the state of air sprayed from an air outlet installed adjacent to the paint nozzle, three types of painting patterns, which are a rectangular pattern 400, an oval pattern 401, and a circular pattern 402, can be mainly formed. When the paint film thickness pattern is the rectangular pattern 400 or the oval pattern 401, a width in a major axis direction is referred to as a pattern width 403, and during painting, the painting gun 100 is moved in a direction perpendicular to a direction of the pattern width 403 (painting line direction). When the paint film thickness pattern is a round pattern, paint is continuously sprayed while moving the painting gun 100 in either the vertical or horizontal (horizontal or vertical) direction.

FIG. 8 illustrates an example of a movement trajectory of a tip position of the painting gun 100. When the painting gun 100 paints the side surface (surface to be painted 22) of the railway vehicle 20, the painting gun 100 is basically moved horizontally in a +X direction, and a trajectory 500a of the painting gun tip 105 is in a direction illustrated in the figure. When painting is finished up to an end of a painting line in the +X direction, paint spraying is suspended, the painting gun 100 is moved by a certain distance in a direction (−Y direction) perpendicular to a direction of the painting line as indicated by an arrow 500b, and then painting is performed as indicated by an arrow 500c in a-X direction. When painting is finished up to a start point in the X direction, paint spraying is suspended, the painting gun 100 is moved by a certain distance in the perpendicular direction (−Y direction) as indicated by an arrow 500d, paint spraying is started again, and painting is continued to a next painting line 500e.

In each of the painting lines 500a, 500c, 500e . . . , the CPU 141 (see FIG. 3) executes the painting gun motion calculation program 152 to fit a straight line 502 (Y=ax+b, a: linear slope, b: y-intercept) to a data string 501 of coordinates (x′, y′) within the surface to be painted in the direction of the painting gun tip direction vector (a, b, c), thereby calculating the linear slope a and the y-intercept b. Further, an angle ψ formed between the fitting straight line 502 in the corresponding painting line and a perpendicular direction of the pattern width is set as levelness 503 of the trajectory. Further, an interval between a fitting straight line 504 in a painting line immediately before the corresponding painting line and coordinates (x′, y′) within the surface to be painted in the direction of the painting gun tip direction vector is defined as a trajectory interval 505 of the painting gun 100. The trajectory interval 505 of the painting gun 100 is generally referred to as a painting alignment interval, and a recommended value differs depending on the shape of the pattern. Normally, as painting alignment, ¾ of the pattern width 403 (see FIG. 7) is recommended for the rectangular pattern, ⅔ thereof is recommended for the oval pattern, and ½ thereof is recommended for the circular pattern. When the painting worker performs painting at a recommended interval, it is possible to obtain a nearly uniform film thickness on the painted surface.

As described above, painting is performed while entirely moving the painting gun 100 in parallel from top to bottom, and painting work is repeated as the trajectories 504 and 503. The levelness of the trajectory of the painting gun 100 can be calculated using Equation (5) from the slope a of the equation of the fitting straight line 502. In addition, the trajectory interval 505 of the painting gun 100 is calculated using Equation (6) from a Y-coordinate (y″), which is obtained by substituting an X-coordinate (x′) within the surface to be painted in the direction of the painting gun tip direction vector on the corresponding painting line into the equation of the fitting straight line 504 in the painting line immediately before the corresponding painting line, and a Y-coordinate (y′) within the surface to be painted in the direction of the painting gun tip direction vector on the corresponding painting line.

$$\begin{matrix}[ Equation 5 ] & \\ ψ = arctan ( a ) & ( 5 )\end{matrix}$$

$$\begin{matrix}[ Equation 6 ] & \\ w = \vert {y}^{″} - {y}^{′} \vert & ( 6 )\end{matrix}$$

The film thickness calculation unit 135 of the painting work management unit 130 calculates a film thickness distribution formed on the surface to be painted 22 from the distance of the painting gun tip 105 to the surface to be painted 22:1, the inclination angle of the painting gun tip 105 with respect to the surface to be painted 22 (horizontal angle: ϕ and vertical angle: θ), and the moving speed of the painting gun 100: v calculated by the painting gun motion calculation unit 133 and paint supply amount information detected by the paint supply machine 110.

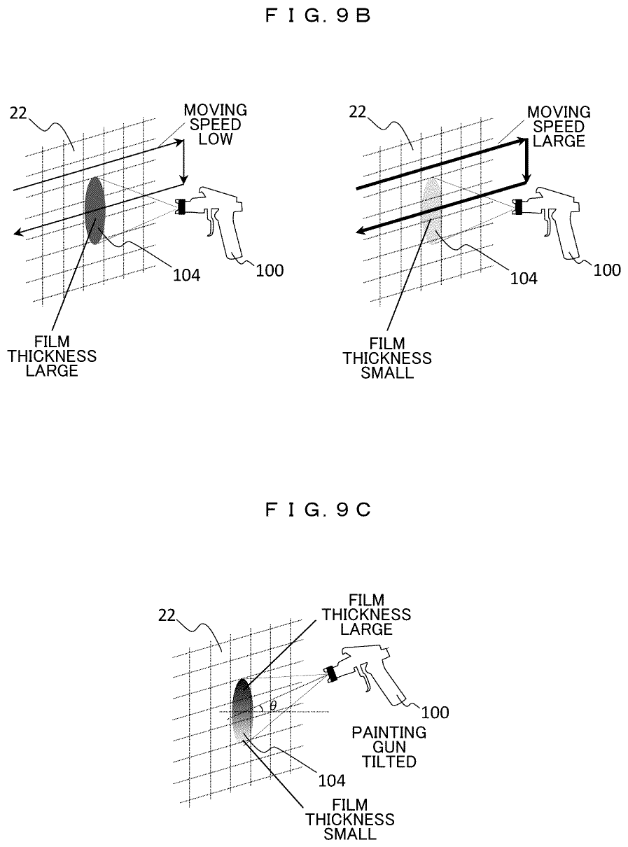

Here, a description will be given of a tendency of a film thickness distribution pattern change with respect to changes of the distance of the tip 105 of the painting gun 100 with respect to the surface to be painted 22, the inclination angle of the painting gun tip 105 with respect to the surface to be painted 22, and the moving speed of the painting gun 100 with reference to FIGS. 9A, 9B, and 9C.

FIG. 9A illustrates a relationship between a distance of the painting gun 100 with respect to the surface to be painted 22 and a paint film thickness pattern, FIG. 9B illustrates a relationship between the moving speed of the painting gun 100 and a paint film thickness pattern, and FIG. 9C illustrates a relationship between a vertical inclination of the surface to be painted 22 and a paint film thickness pattern. In the figures, the painting pattern 107 by the painting gun 100 is illustrated. However, as illustrated in a left drawing of FIG. 9A, when a distance between the painting gun 100 and the surface to be painted 22 is short, a paint film thickness pattern formed on the surface to be painted 22 becomes small, and thus paint becomes dense and the film thickness increases. As illustrated in a right drawing thereof, when the distance between the painting gun 100 and the surface to be painted 22 is long, a paint film thickness pattern formed on the surface to be painted 22 becomes large, and thus paint is dispersed and the film thickness decreases.

In addition, as illustrated in a right drawing of FIG. 9B, when a speed at which the painting gun 100 is moved is high, paint transfer efficiency (ratio of the mass of the applied amount to the mass of paint actually attached to the object to be painted) decreases due to an influence of airflow, and the pain film thickness decreases. As illustrated in a left drawing thereof, when the speed at which the painting gun 100 is moved is low, paint transfer efficiency increases and the film thickness increases.

In addition, as illustrated in FIG. 9C, when the painting gun 100 is tilted in the vertical direction with respect to the surface to be painted 22, the paint film thickness becomes large in a spot where the distance between the painting gun 100 and the surface to be painted 22 becomes small, and the paint film thickness becomes small in a spot where the distance between the painting gun 100 and the surface to be painted 22 becomes long, so that the film thickness formed on the surface to be painted 22 becomes non-uniform.

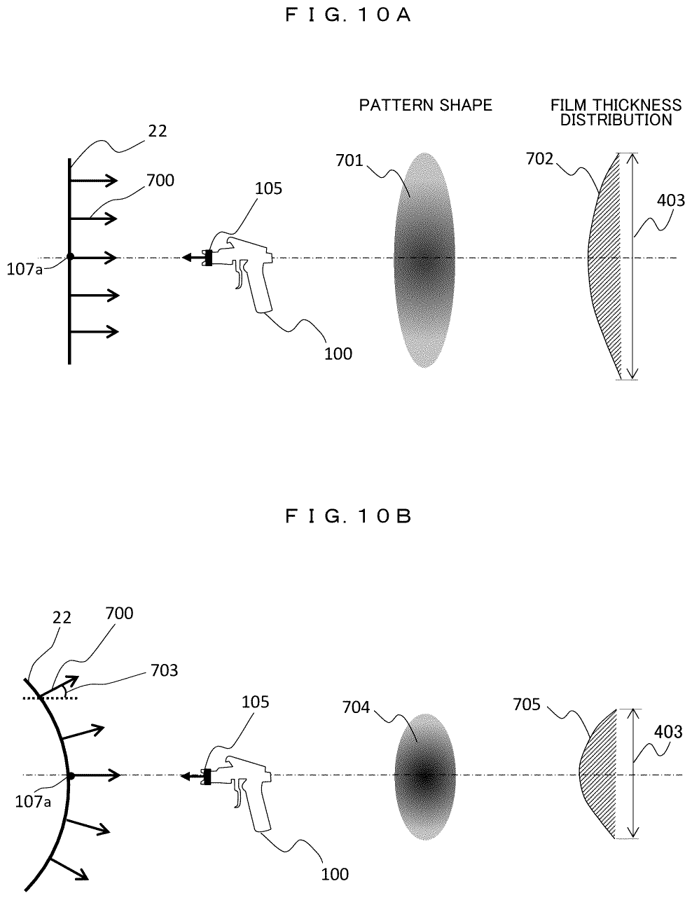

Furthermore, a description will be given of a tendency of a paint film thickness pattern when the surface to be painted is a curved surface with reference to FIG. 10. FIG. 10A illustrates a paint film thickness pattern 701 and a film thickness distribution 702 in a pattern width direction when the surface to be painted 22 is a flat surface (a normal vector 700 is constant at each position on the surface to be painted), and FIG. 10B illustrates a paint film thickness pattern 704 and a film thickness distribution 705 in a pattern width direction when a surface to be painted 23 is a curved surface (the normal vector 700 is different depending on each position on the surface to be painted). In FIGS. 10A and 10B, a position of a painting center 107a on the surface to be painted with respect to each painting gun tip 105 is the same. However, an inclination angle 703 of each normal vector 700 with respect to a direction vector of the painting gun tip 105 increases as each position on the surface to be painted becomes farther from the painting center 107a, and thus paint transfer efficiency on the surface to be painted of FIG. 7B decreases when compared to FIG. 7A. For this reason, in the film thickness distribution 705 of FIG. 10B, the film thickness rapidly decreases toward an edge of a pattern width when compared to the film thickness distribution 702 of FIG. 10A. Further, the paint film thickness pattern 704 of FIG. 10B tends to become small in the vertical direction with respect to the paint film thickness pattern 701 of FIG. 10A.

Based on the above tendencies, the painting work management device 10 in this embodiment has a model formula that represents a film thickness distribution pattern according to painting conditions (a distance of the painting gun tip 105 with respect to a position of the painting center 107a on the surface to be painted 22, an inclination angle of the painting gun tip 105 with respect to each local region on the surface to be painted 22, a moving speed of the painting gun 100), and the model formula can be expressed as Equation (7) to Equation (14).

$$\begin{matrix}[ Equation 7 ] & \\ {P}_{s} ( {x}_{s} ) = α ( v ) \cdot β ( l ) \cdot T ( {x}_{0} , {θ}_{s} ) \cdot {P}_{0} ( \frac{{x}_{0}}{γ ( t )} ) & ( 7 )\end{matrix}$$

$$\begin{matrix}[ Equation 8 ] & \\ α ( v ) = a \cdot {v}^{3} + b \cdot {v}^{2} + c \cdot v + d & ( 8 )\end{matrix}$$

$$\begin{matrix}[ Equation 9 ] & \\ β ( l ) = e \cdot {l}^{3} + f \cdot {l}^{2} + g \cdot l + h & ( 9 )\end{matrix}$$

$$\begin{matrix}[ Equation 10 ] & \\ γ ( l ) = o \cdot {l}^{3} + p \cdot {l}^{2} + q \cdot l + r & ( 10 )\end{matrix}$$

$$\begin{matrix}[ Equation 11 ] & \\ T ( {x}_{0} , {θ}_{s} ) = \frac{{( l \cdot cos θ - {x}_{0} \cdot sin {θ}_{s} )}^{2}}{l \cdot cos {θ}_{s}} & ( 11 )\end{matrix}$$

$$\begin{matrix}[ Equation 12 ] & \\ {x}_{0} = \frac{l \cdot {x}_{s}}{{l}_{0} + {y}_{s}} & ( 12 )\end{matrix}$$

$$\begin{matrix}[ Equation 13 ] & \\ l = {l}_{0} - {x}_{s} \cdot tan {θ}_{s} + {y}_{s} & ( 13 )\end{matrix}$$

$$\begin{matrix}[ Equation 14 ] & \\ {l}_{0} = \sqrt{{( {x}_{k} - {x}_{k}^{′} )}^{2} + {( {y}_{k} - {y}_{k}^{′} )}^{2} + {( {z}_{k} - {z}_{k}^{′} )}^{2}} & ( 14 )\end{matrix}$$

### <Description of Each Function and Parameter>

Pₛ (xₛ): Film thickness distribution function on surface to be painted
P₀ (x₀): Reference film thickness distribution function under standard condition

### (Polynomial Approximation of Measured Film Thickness Data Under Standard Condition)

α(v): Paint transfer efficiency at painting gun moving speed
β(l): Paint transfer efficiency according to distance of painting gun tip with respect to surface to be painted
γ(l): Pattern width expansion rate depending on distance of painting gun tip with respect to surface to be painted
T(x₀, θₛ): Surface-to-be-painted inclination coordinate transformation function
x₀: Pattern width direction position coordinates of reference film thickness distribution
xₛ: Pattern width direction position of each local region on surface to be painted (start point of painting center)
yₛ: Surface normal direction position of each local region on surface to be painted (start point of painting center)
v: Painting gun moving speed
l₀: Painting distance with respect to painting center on surface to be painted
θ: Inclination angle in vertical direction of painting gun at painting center on surface to be painted
θₛ: Inclination angle of painting gun with respect to normal at position (xₛ, yₛ) on surface to be painted
x, y, z: Painting gun tip position coordinates
x′, y′, z′: Painting center position coordinates
a, b, c, d, e, f, g, h, o, p, q, r: Coefficients (calculated from experimental data)

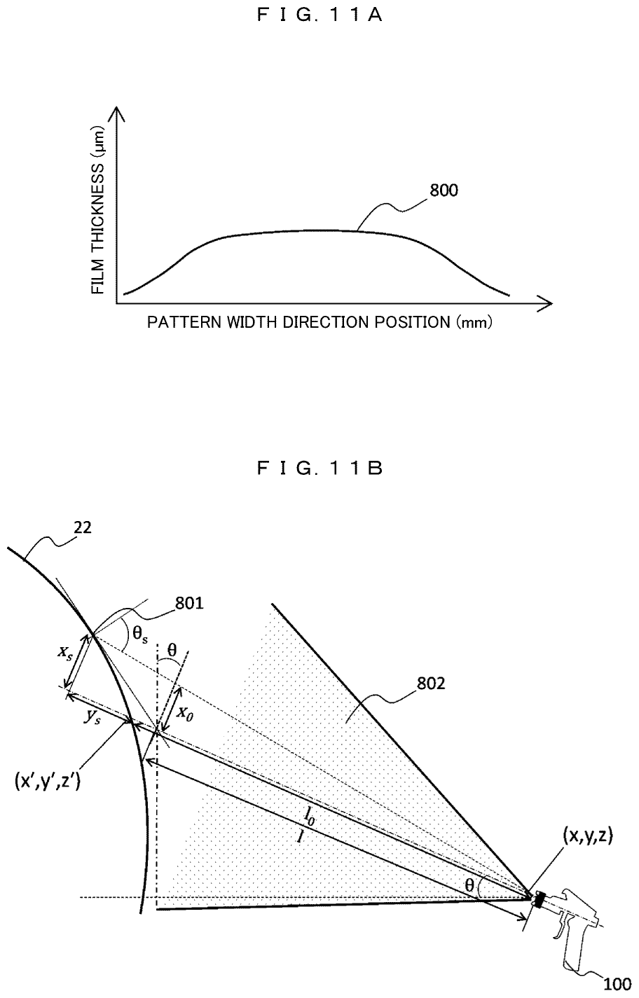

The above model formula will be described below with reference to FIGS. 11A and 11B. Equation (7) represents a film thickness distribution in a pattern width direction formed around position coordinates (x′, y′, z′) of the painting center 107a when the painting gun is moved at a constant speed. FIG. 11A illustrates a film thickness distribution 800 in a pattern width direction under a standard painting condition, and FIG. 11B illustrates a geometric relationship between the painting gun and the surface to be painted when the surface to be painted 22 has a curved shape within a pattern width region and the painting gun is tilted in the vertical direction. By considering a change in an inclination angle in each local region on a 3D model surface from information of object-to-be-printed shape data (3D model data) held by the painting work management unit in addition to information of a vertical inclination angle of the painting gun 100, a film thickness distribution is calculated taking into account a change in a film thickness distribution pattern caused by a change in the inclination angle in each local region within the pattern width of the surface to be painted.

The film thickness distribution function: Pₛ (xₛ) in the pattern width direction illustrated by Equation (7) is expressed by setting a film thickness distribution pattern at each of standard values (hereinafter referred to as standard conditions) of the distance of the painting gun tip 105 with respect to the painting center on the surface to be painted, the inclination angle of the painting gun tip 105 in each local region on the surface to be painted, and the moving speed of the painting gun 100 to the reference film thickness distribution function: P₀ (x₀) and using this reference film thickness distribution function, the function: α(v) representing an influence of the moving speed: v of the painting gun 100 illustrated by Equation (8), the function: β(l) representing an influence of the distance: l of the painting gun tip 105 with respect to the painting center on the surface to be painted illustrated by Equation (9), the pattern width expansion rate γ(l) by the distance: l of the painting gun tip 105 with respect to the painting center on the surface to be painted illustrated by Equation (10), and the function T(x₀, θₛ) representing an influence of the vertical inclination angle: θₛ of the painting gun 100 with respect to each local region 801 within the pattern width of the surface to be painted illustrated by Equation (11).

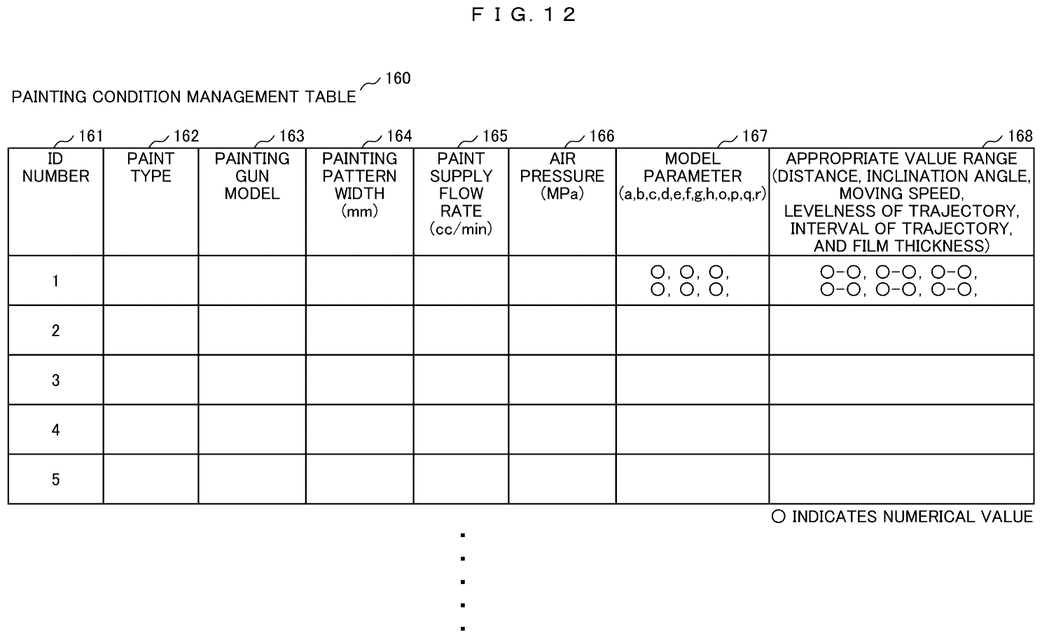

Further, each of the functions (7) to (11) can be expressed as a polynomial function based on a plurality of model parameters (a, b, c, d, e, f, g, h, o, p, q, and r) depending on the change of the painting condition. For this reason, as illustrated in FIG. 12, the painting work management device 10 holds the painting condition management table 160 that shows model parameter values corresponding to combinations of these paint/painting gun conditions, and selects a model parameter set according to the paint/painting gun conditions during painting.

Note that the reference film thickness distribution function may be obtained as an approximate formula for an actual measurement result by actually measuring the film thickness distribution in the pattern width direction when painting is performed under the above standard conditions using a film thickness meter, or may be obtained by calculation from a simulation of the paint film thickness depending on the standard conditions.

In addition, the painting state analysis unit 136 of the painting work management unit 130 specifies a motion state of the painting gun 100 related to the distance of the painting gun tip 105 with respect to the surface to be painted during occasional painting, the inclination angle of the painting gun tip 105 with respect to the surface to be painted, the moving speed of the painting gun 100, the levelness of the trajectory of the painting gun 100, and the interval of the trajectory of the painting gun 100 and a state of the film thickness distribution based on the distance of the painting gun tip 105 with respect to the surface to be painted during occasional painting, the inclination angle of the painting gun tip 105 with respect to the surface to be painted, the moving speed of the painting gun 100, the levelness of the trajectory of the painting gun 100, and the interval of the trajectory of the painting gun 100 calculated by the painting gun motion calculation unit 133 and film thickness distribution data formed on the painted surface of the object to be painted calculated by the film thickness calculation unit 135.

For this reason, as illustrated in FIG. 12, the painting work management device 10 holds the painting condition management table 160. The painting condition management table 160 holds values of an appropriate range of painting gun motion according to the paint/painting gun condition (the distance of the painting gun tip 105 with respect to the surface to be painted 22 during occasional painting, the inclination angle of the painting gun tip 105 with respect to the surface to be painted, the moving speed of the painting gun 100, the levelness of the trajectory of the painting gun 100, and the interval of the trajectory of the painting gun 100) and an appropriate range of the paint film thickness. The CPU 141 determines whether or not the specified state of the painting gun motion and the specified state of the film thickness distribution are within the appropriate ranges, respectively, based on the appropriate ranges. Note that each of the above appropriate ranges is determined by conducting a painting test in advance and obtaining a range in which there are no painting defects (for example, sagging, fading, etc.) under each paint/painting gun condition.

The painting condition management table 160 has each of fields of an ID number 161, a paint type 162, a painting gun model 163, a painting pattern width 164, a paint supply flow rate 165, an air pressure 166, a model parameter set 167, and an appropriate value range set 168.

Numbers for identifying respective paint/painting gun conditions are sequentially stored from 1 in the ID number 161. Information about a paint product name is stored in the paint type 162. A model name of the painting gun 100 is stored in the painting gun model 163. A painting pattern width is stored in units of “mm” in the painting pattern width 164. A flow rate of paint supplied to the painting gun is stored in units of “cc/min” in the paint supply flow rate 165. An air pressure value is stored in units of “MPa” in the air pressure 166. Values of model parameters (a, b, c, d, e, f, g, h, o, p, q, and r) are separated by commas and stored in the model parameter set 167. Values of respective appropriate ranges (lower limit and upper limit) for
(1) the distance (mm) of the painting gun 100 with respect to the painting center on the surface to be painted,
(2) inclination angle (°) of the painting gun 100 with respect to the surface to be painted,
(3) moving speed (mm/s) of the painting gun 100,
(4) levelness (°) of the painting trajectory,
(5) interval (mm) of the painting trajectory, and
(6) the paint film thickness (μm)
are separated by commas and stored in the appropriate value range set 168 in the order of (1) to (6), and “-” is inserted between the lower limit and the upper limit in each appropriate range.

The painting state/work instruction unit 137 of painting work management unit 130 outputs the state of the film thickness distribution (within the appropriate range and outside the appropriate range) and the painting gun motion determined by the painting state analysis unit 136 to a wearable device such as the HMD 147 wearable by the worker, and issues an instruction during painting work. As an instruction method, characters may be displayed on a screen of a terminal. However, to facilitate recognition by the worker during painting, it is also effective to emit an alert sound in the case of being outside the applicable range or change a color of a display in the case of falling within or being outside an applicable range (for example, display in green in the case of falling within the applicable range and red in the case of being outside the applicable range) by displaying an indicator such as a lamp on the terminal screen.

In addition, at the same time, the painting state/work instruction unit 137 of the painting work management unit 130 sequentially converts film thickness distribution results in the pattern width direction at coordinates (x′, y′) on the surface to be painted in the direction of the painting gun tip direction vector calculated by the film thickness calculation unit 135 into 2D or 3D film thickness distribution images, and outputs the images to the wearable terminal such as the HMD 147 to perform display.

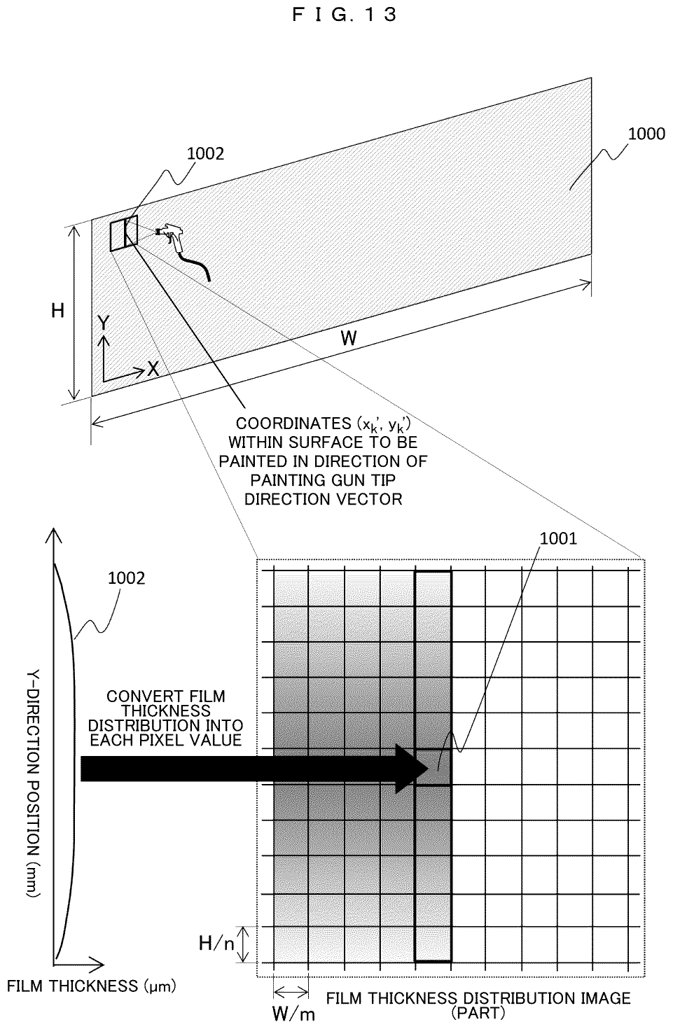

A film thickness distribution image (2D distribution image) output to the HMD 147 or the output device 149 will be described below with reference to FIG. 13. In the film thickness distribution image, a horizontal direction corresponds to an X-axis (painting line direction) of a painting area 1000 on surface to be painted, a vertical direction corresponds to a Y-axis (pattern width direction) of the painting area 1000, and a value (vertical direction: W/n (mm), horizontal direction: H/m (mm)) obtained by dividing a painting area range (width: W (mm), height: H (mm)) on the surface to be painted by the number of pixels in each axis (n, m) of the film thickness distribution image becomes spatial resolution (1 pixel dimension) of the image.

Further, with regard to the film thickness distribution image, the film thickness distribution 800 in the pattern width direction at coordinates (x′, y′) within the surface to be painted in the direction of the painting gun tip direction vector calculated by the film thickness calculation unit 135 is converted into a gradation value of each pixel, and the image is displayed by assigning the gradation value to shading (gray scale) or hue at a center of a pixel 1001 corresponding to (x′, y′). Furthermore, when an overlapping part occurs in the painting pattern due to subsequent painting lines, for pixels in the overlapping part, the sum of film thickness values in the overlapping part in each painting line is calculated, and a pixel value is updated by reflecting a calculation result. Note that various instructions to the worker, for example, an instruction to repaint a specific spot, an instruction with regard to posture or speed of the painting gun 100 (an inclination of the gun is large or a speed is excessively high), etc. may also be displayed within the image display of the film thickness distribution 800 illustrated in FIG. 13.

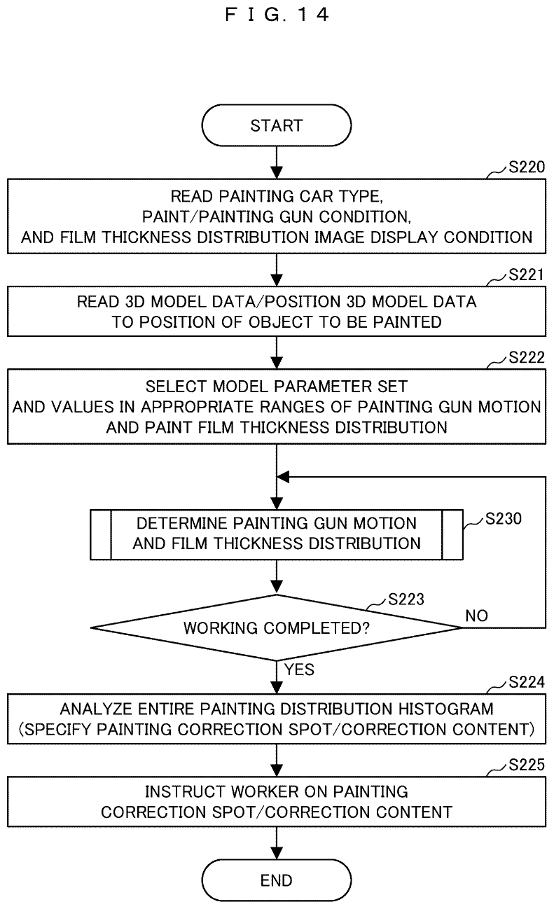

Next, a flow of processing when implementing the invention will be described with reference to FIG. 14.

First, as a pre-painting work stage, the painting worker inputs information about a painting car type, a paint/painting gun condition, and a film thickness distribution image display condition (painting area range dimensions and the number of pixels) to an input screen (not illustrated) output to a display device of the painting work management device 10, and reads 3D model data of the object to be painted to the device (step 220).

Next, the position detection sensor 121 of the measurement unit 120 detects a plurality of marker positions attached to respective feature positions on the surface to be painted of the object to be painted, coordinate values (xmₖ, ymₖ, zmₖ); (0≤k≤n) of each feature position on the surface to be painted in the measurement coordinate system of the measurement unit 120 are calculated, and the shape data position adjustment unit 132 of the painting work management unit 130 positions the 3D model data to a position of the object to be painted in the measurement coordinate system of the measurement unit 120 from the calculated coordinates and coordinate values (xdₖ, ydₖ, zdₖ); (0≤k≤n) of the 3D model data corresponding to each feature position (step 221).

Next, the painting work management device searches the painting condition management table 160 held by the device, and selects a model parameter set that matches information on the paint/painting gun condition input in step 220 and values in appropriate ranges related to the painting gun motion and the paint film thickness distribution (step 222).

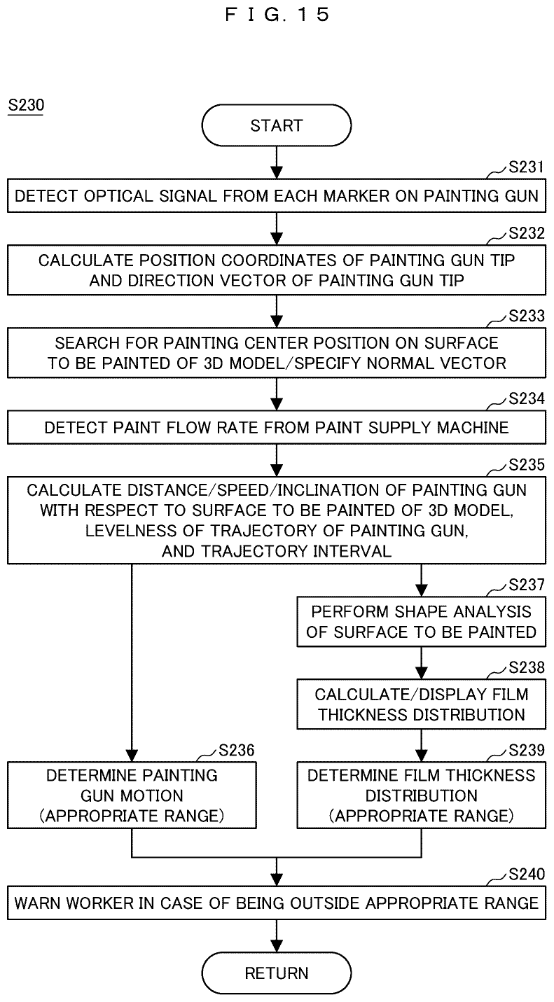

When step 222 is completed and actual painting work is started, the painting gun motion during the work and the film thickness distribution are determined (step 230). A flowchart of FIG. 15 illustrates a detailed procedure of step 230. In FIG. 15, the painting work management device uses the position detection sensor 121 of the measurement unit 120 to occasionally detect an optical signal from each marker on the painting gun during painting (step 231).

Next, the marker analysis unit 122 of the measurement unit 120 calculates the occasional 3D position coordinates (x, y, z) of the painting gun tip 105 in the painting work space and the direction vector (a, b, c) of the painting gun tip 105 based on the detected optical signal from each marker (step 232).

Further, the painting center on the surface to be painted of the 3D model positioned to the position of the object to be painted in step 222 is searched for from the position coordinates (x, y, z) of the painting gun tip 105 and the direction vector (a, b, c) of the painting gun tip 105 calculated in step 232, and painting center coordinates (x′, y′, z′) and the normal vector (α, β, γ) at the painting center 107a are specified (step 233).

In addition, the painting work management device detects a paint supply flow rate using a paint flow meter illustrated) of the paint supply machine 110 (step 234).

Next, the painting work management device uses the painting gun motion calculation unit 133 of the painting work management unit 130 to calculate a distance of the painting gun tip 105 with respect to the painting center 107a on the surface to be painted: l, an inclination angle of the painting gun tip 105 with respect to the painting center 107a on the surface to be painted (horizontal angle: ϕ and vertical angle: θ), a moving speed of the painting gun tip 105: v, levelness of the trajectory of the painting gun 100, and the interval of the trajectory of the painting gun 100 from (x, y, z) and (a, b, c) calculated in step 232 and the normal vector (α, β, γ) at the coordinates (x′, y′, z′) of the painting center 107a (step 235).

Next, the painting work management device specifies a painting pattern width region on the surface to be painted of the 3D model data using the surface-to-be-painted shape analysis unit 134 of the painting work management unit 130 from the coordinates (x′, y′, z′) of the painting center 107a on the surface to be painted calculated in step 233 and the vertical inclination angle of the painting gun tip 105 with respect to the painting center 107a on the surface to be painted calculated in step 235, and performs shape analysis of the painting pattern width region (analysis of an inclination angle in each local region in a painting pattern width direction) (step 237).

Next, the film thickness calculation unit 135 of the painting work management unit 130 calculates a film thickness distribution formed around coordinates (x′, y′) within the surface to be painted in the direction of the painting gun tip direction vector by substituting the model parameter set selected in step 222, the distance of the painting gun 100 with respect to the painting center position on the surface to be painted of the painting gun 100 calculated in the step 235, the moving speed of the painting gun 100, and the inclination angle of the painting gun 100 with respect to each local region position on the surface to be painted analyzed in the step 237 into Equation (7) of the film thickness distribution pattern model held by the painting work management device, and the painting state/work instruction unit 137 of the painting work management unit 130 displays a film thickness distribution image based on the film thickness distribution image display condition (painting area dimensions and the number of pixels) input in step 220 (step 238).

In addition, in parallel with processing of step 238, the painting state analysis unit 136 of the painting work management unit 130 compares the painting gun motion related to the distance of the painting gun tip 105 with respect to the surface to be painted, the inclination angle of the painting gun tip 105 with respect to the painting center 107a on the surface to be painted, the moving speed of the painting gun tip 105, levelness of the trajectory of the painting gun 100, and the interval of the trajectory of the painting gun 100 calculated in step 235 with a value in the appropriate range of the painting gun motion selected in step 222, and determines whether a value of the painting gun motion calculated in step 235 falls within the appropriate range (step 236).

In addition, in parallel with processing of step 236, the painting state analysis unit 136 of the painting work management unit 130 compares a value of the film thickness distribution calculated in step 238 with the value in the appropriate range of the film thickness distribution selected in step 222 (see FIG. 14), and determines whether the value of the film thickness distribution calculated in step 238 falls within the appropriate range (step 239).

Based on a state analysis result of the painting gun motion according to step 236 and a state analysis result of the film thickness distribution according to step 239, when the painting gun motion or the film thickness distribution state is outside the appropriate range selected in step 222, the painting state/work instruction unit 137 of the painting work management unit 130 issues a warning to the worker by outputting and displaying on the HMD 147, etc. (see FIG. 3) or by making an alert sound (step 240).

When a series of processes from step 231 to step 240 is completed, the process returns to FIG. 14 and proceeds to step 224. Step 230 is repeated until the painting work is finished, and after the painting work is finished, the process proceeds to step 224.

The painting state analysis unit 136 of the painting work management unit 130 creates a histogram of each pixel value in the film thickness distribution image of the entire painting area range according to step 238, and specifies a position of a painting correction spot and content of painting correction by analyzing the histogram (step 224).

Next, the painting state/work instruction unit 137 of the painting work management unit 130 displays position information and correction content of the correction spot specified in step 236 on the HMD 147 or the screen of the output device 149, thereby instructing the worker on the information (step 225).

Through the above-mentioned series of processes, it is possible to improve painting quality by making the paint film thickness uniform in manual painting by the worker, and to ensure protection and an aesthetic appearance by ensuring an appropriate film thickness value. Furthermore, it is possible to reduce the use of unnecessary paint, contributing to reductions in painting costs and emissions of volatile organic substances. Note that, even though an example in which the painting work management device according to the invention is applied to manual painting has been illustrated in this embodiment, the invention is not limited to manual painting, and it is obvious that application to verification work of a film thickness distribution state is possible when the invention is applied to robot painting.

A program of the invention causes an information processing device having the CPU to execute the painting work management method illustrated in FIGS. 14 and 15. That is, the program is a program for causing a computer to execute the painting work management method of managing painting work for performing painting by spraying paint to an object to be painted using a painting gun, and is a program for executing a step of specifying a position of a painted surface of the object to be painted to position 3D model data of the object to be painted to the position of the painted surface, a step of specifying a distance of the painting gun 100 with respect to a painted surface of shape data of the object to be painted, an inclination angle with respect to the painted surface of the shape data of the object to be painted, and a moving speed of the painting gun 100 from a position and a posture of the painting gun 100 with respect to the painted surface of the shape data of the object to be painted measured by the measurement unit, and a step of calculating a film thickness distribution formed on the painted surface of the object to be painted based on information related to the distance of the painting gun 100 with respect to the painted surface of the shape data of the object to be painted, the inclination angle with respect to the painted surface of the shape data of the object to be painted, and the moving speed of the painting gun 100 and model formula information representing a film thickness distribution pattern according to a shape of the surface to be painted in the shape data of the object to be painted. Furthermore, the program is a program for executing a step of determining whether a state of painting gun motion is within an appropriate range based on at least one of the distance of the painting gun 100 with respect to the painted surface of the shape data of the object to be painted, or the inclination angle of the painting gun 100 with respect to the painted surface of the shape data of the object to be painted, the moving speed of the painting gun 100, levelness of the trajectory of the painting gun 100, and an interval of the trajectory of the painting gun 100, and/or whether a state of a film thickness distribution is within an appropriate range based on a film thickness distribution formed on the painted surface of the object to be painted, and a step of instructing the worker on a determination result during painting work.

Note that the invention is not limited to the above-described embodiments, and includes various modifications. For example, the above-described embodiments are described in detail to describe the invention in an easy-to-understand manner, and the invention is not necessarily limited to having all the configurations described.

What is claimed is:

1. A painting work management device configured to manage painting work for performing painting by spraying paint to an object to be painted using a painting gun, the painting work management device comprising:
a measurement unit configured to measure a position and a posture of the painting gun with respect to a surface to be painted of the object to be painted; and
a painting work management unit configured to calculate a film thickness formed on the object to be painted by spraying the paint,
wherein the painting work management unit is configured to:
hold shape data of the object to be painted,
specify a distance of the painting gun with respect to a surface to be painted of the shape data of the object to be painted, an inclination angle of the painting gun with respect to the surface to be painted of the shape data of the object to be painted, and a moving speed of the painting gun, and
calculate a film thickness distribution formed on the surface to be painted of the object to be painted based on information related to the distance, the inclination angle, and the moving speed of the painting gun and information of a model formula representing a film thickness distribution pattern corresponding to the shape data of the object to be painted.

2. The painting work management device according to claim 1, wherein:
a shape of the surface to be painted in the shape data of the object to be painted is indicated by a normal vector of each local region included in the surface to be painted,
the inclination angle of the painting gun is indicated by a tip direction vector of the painting gun, and
the painting work management unit calculates the film thickness distribution using the normal vector and the tip direction vector.

3. The painting work management device according to claim 2, wherein the painting work management unit specifies a position of the object to be painted in a measurement coordinate system of the measurement unit, and positions the shape data of the object to be painted to the specified position of the object to be painted to calculate a distance of a tip of the painting gun with respect to the surface to be painted of the shape data of the object to be painted or an inclination angle of data of the object to be painted with respect to the surface to be painted.

4. The painting work management device according to claim 2, wherein the painting work management unit is configured to:
store a parameter expressing a change in the film thickness distribution pattern due to a change of the inclination angle in advance as a model formula,
detect an inclination angle of each local region with respect to a painting gun tip direction from the normal vector of each local region of the object to be painted, and
calculate a film thickness distribution in the local region using the detected inclination angle and the model formula.

5. The painting work management device according to claim 1, wherein:
a display device allowed to be recognized by a worker during painting work is provided, and
the painting work management unit specifies, from the calculated film thickness distribution, a region where paint is insufficient or excessive on the surface to be painted of the object to be painted, and displays the region on the display device.

6. A program for causing a computer to execute a painting work management method of managing painting work for manually spraying paint to an object to be painted using a painting gun, the program causing the computer to execute steps of:
specifying a distance of the painting gun with respect to a surface to be painted of shape data of the object to be painted, an inclination angle of the painting gun with respect to the surface to be painted of the shape data of the object to be painted, and a moving speed of the painting gun from a position and a posture of the painting gun measured by a measurement unit configured to measure a position and a posture of the painting gun with respect to the surface to be painted of the object to be painted,
calculating a film thickness distribution formed on the surface to be painted of the object to be painted based on information related to the distance, the inclination angle, and the moving speed of the painting gun and information of a model formula representing a film thickness distribution pattern corresponding to a shape of the surface to be painted in the shape data of the object to be painted,
determining whether a motion state of the painting gun is within an appropriate range and/or whether a state of the film thickness distribution is within an appropriate range, and displaying a result of the determination on a display device allowed to be recognized by a worker during painting work.

7. The program according to claim 6, wherein the determining comprises determining based on at least one of the distance, the inclination angle, and the moving speed of the painting gun, levelness of a trajectory of the painting gun, and an interval of the trajectory of the painting gun.

8. The program according to claim 7, wherein the displaying comprises specifying, from the calculated film thickness distribution, a region where paint is insufficient or excessive on the surface to be painted of the object to be painted, and displaying the region.

9. The program according to claim 8, wherein a shape of the surface to be painted of the object to be painted is indicated by a normal vector of each local region included in the surface to be painted, the inclination angle of the painting gun is indicated by a tip direction vector of the painting gun, and a film thickness distribution pattern is calculated using an amount of change in an angle formed by the normal vector and the tip direction vector.

10. A railway vehicle painted by a painting gun spraying paint to an object to be painted using a painting work management device including a measurement unit configured to measure a position and a posture of the painting gun with respect to a surface to be painted of the object to be painted, and painting work management unit configured to calculate a film thickness formed on the object to be painted by spaying paint, wherein painting is performed while the measurement unit repeats steps of:
measuring the position and the posture of the painting gun,
reading three-dimensional (3D) shape data of the object to be painted,
specifying a distance of the painting gun with respect to a surface to be painted of the 3D shape data, an inclination angle of the painting gun with respect to the surface to be painted of the 3D shape data, and a moving speed of the painting gun from the position and the posture of the painting gun measured by the measurement unit,
calculating a film thickness distribution formed on the surface to be painted of the object to be painted based on information related to the distance, the inclination angle, and the moving speed of the painting gun and information of a model formula representing a film thickness distribution pattern corresponding to a shape of the surface to be painted in the shape data of the object to be painted, and
determining whether or not the film thickness distribution formed on the surface to be painted is appropriate and displaying a result thereof to a worker using a display device.

11. The railway vehicle according to claim 10, wherein:
the shape of the surface to be painted in the 3D shape data is indicated by a normal vector of each local region included in the surface to be painted, and
the calculating comprises indicating the inclination angle of the painting gun by a tip direction vector of the painting gun, and calculating the film thickness distribution pattern using an amount of change in an angle formed by the normal vector and the tip direction vector.

12. The railway vehicle according to claim 10, wherein the determining whether or not the film thickness distribution formed on the surface to be painted is appropriate, comprises specifying a region where paint is insufficient or excessive on the surface to be painted of the object to be painted, and performing painting by prompting a worker to perform additional painting.
